(19) United States
(12) Patent Application Publication
(10) Pub. No.: US 2021/0129640 A1
(43) Pub. Date: May 6, 2021

(54) Convertible Truck Cap

(71) Applicant: Truck Accessories Group, LLC, Elkhart, IN (US)

(72) Inventors: Terry D'Hoore, South Bend, IN (US); Fred Bournay, Jr., Dowagiac, MI (US); Matt Baus, Avilla, IN (US); Anthony Massafra, Austin, TX (US); Jesse James, Austin, TX (US)

(21) Appl. No.: 17/084,022

(22) Filed: Oct. 29, 2020

Related U.S. Application Data
(60) Provisional application No. 62/929,337, filed on Nov. 1, 2019.

(51) Int. Cl. B60J 7/04

(52) U.S. Cl. CPC B60J 7/041

(57) ABSTRACT

A convertible truck cap for use on a truck bed of a pickup truck is provided. The convertible truck cap includes multiple roof bows, each of which extend upwardly from the truck bed. At least the second roof bow is slidably movable to be positionable between a non-cap use stowed position and a cap use frame position with respect to another roof bow. A plurality of side panels selectively fasten to the roof bows with at least one fastener. At least one roof panel spans the roof bows at a location configured to be above the truck bed.

### RELATED APPLICATIONS

The present Application relates to and claims priority to U.S. Provisional Patent Application, Ser. No. 62/929337, filed on Nov. 1, 2019. The subject matter disclosed in that Provisional Application is hereby expressly incorporated into the present Application.

### TECHNICAL FIELD AND SUMMARY

The present disclosure relates to trucks such as pickup trucks with truck beds or cargo boxes, and, in particular, a convertible truck bed cap with components that allow a simplified conversion between installing the cap over the truck bed and removing the cap from the truck bed.

A truck cap is an enclosure that attaches to the top sidewalls of a pickup truck. The truck cap includes upward extending side and forward walls, and a door typically positioned on the rearward end above the pickup truck tailgate (although the door can be placed anywhere on the truck). Typically, the upward extending walls terminate at the approximate height of the pickup truck's cab section roof. This configuration enhances the pickup truck's aesthetic appearance similar to an SUV while at the same time expanding the volume of under-roof storage space in the truck bed.

In some instances, however, it is not desirable to employ a cap over the bed of the pickup truck. Reasons include carrying cargo like wood or furniture that is too large for the enclosed space defined by the cap or is oddly shaped or configured to load through only the rear cap door and tailgate. In further instances, it may be desirable to employ the truck bed for outside recreational activities where persons may prefer to sit in the truck bed without the truck cap enclosing same.

Truck caps that cover the full bed of a pickup truck tend to be relatively large structures that are also heavy and require multiple persons to install or remove the truck cap. For practical purposes, truck caps, although an accessory to a pickup truck, are not easily installed or removed so they tend to be a permanent fixture thereon. In contrast, the present disclosure provides a convertible truck bed cap. This truck cap may be readily assembled or disassembled over the truck bed, particularly by a single individual, with relative ease. This is believed to enhance the utility of the truck bed for tasks that may employ use of a truck cap and tasks that may not.

Accordingly, an illustrative embodiment of the present disclosure provides a convertible truck cap for use on a truck bed of a pickup truck. The convertible truck cap comprises: a first rail to be located on a first sidewall of the truck bed; a second rail to be located on a second sidewall of the truck bed; each of the first and second rails include a linearly extending bearing; first, second, and third roof bows; each of the first, second, and third roof bows extend upwardly from the first and second rails and over the truck bed; at least the second and third roof bows are slidably coupled to the linearly extending bearings of the first and second rails to allow the at least the second and third roof bows to slide along the first and second rails and be positionable between a non-cap use stowed position, and a cap use frame position; the at least the second and third roof bows are selectively slidable toward the first roof bow to the non-cap use stowed position; the linearly extending bearings of the first and second rails each includes a plurality of spaced apart notches and the at least the second and third roof bows each include at least one detent to selectively engage one of the plurality of spaced apart notches; when the at least the second and third roof bows are positioned in the cap use frame position the at least the second and third roof bows are spaced apart from each other and from the first roof bow; a plurality of side panels; wherein a first side panel of the plurality of side panels spans at least between the first and second roof bows at a location where the first and second roof bows extend upwardly from the first rail; wherein the first side panel of the plurality of side panels selectively fastens to the first and second roof bows with at least one fastener; and at least one roof panel spans at least between the first and second roof bows at a location configured to be above the truck bed.

In the above and other embodiments, the convertible truck cap may further comprise: the at least one roof panel selectively fastens to the first and second roof bows with at least one connector; at least one of the first, second, and third roof bows being composed of at least one upward extending post, at least one laterally extending crossbeam, and at least one corner member that connects to the at least one upward extending post and the at least one laterally extending crossbeam; at least one of the first, second, and third roof bows is disassemblable into components; a door that is attachable to at least one of the first, second, and third roof bows, wherein the door is movable with respect to the convertible truck cap between open and closed positions; a door that is attachable to the third roof bow to allow selective access to the truck bed; a front panel attachable to one of the first, second, and third roof bows, and to be located adjacent a cab portion of the pickup truck; the at least one fastener being held onto the at least a first side panel of the plurality of side panels when not fastened to at least one of the first and second roof bows by a structure selected from the group consisting of a washer, nut, spring nut, and clip; a second side panel of the plurality of side panels selectively fastens to the second and third roof bows with at least one fastener, a third side panel of the plurality of side panels selectively fastens to the first and second roof bows with at least one fastener at a location opposite the first side panel, a fourth side panel of the plurality of side panels selectively fastens to the second and third roof bows with at least one fastener at a location opposite the second side panel; a second roof panel that selectively fastens to the second and third roof bows with at least one connector; the each of the first, second, and third roof bows being composed of at least one material that is selected from the group consisting at least one of billet aluminum, cast aluminum, aluminum, metal alloy, fiberglass, and plastic; each of the plurality of side panels being composed of a metal sheet; the at least the second and third roof bows each include at least one lever in communication with the detent to move the detent in order to release the detent from the one of the spaced apart notches; the at least one of the first, second, and third roof bows include a recess that receives the first side panel of the plurality of side panels such that at least a portion of an exterior surface of the first side panel of the plurality of side panels is essentially flush with a surface adjacent the recess of the at least one of the first, second, and third roof bows; the at least the second and third roof bows are selectively slidable adjacent the first roof bow to the non-cap use stowed position; and at least one of the first and second rails includes a stop member to limit movement of at least one of the first, second, and third roof bows from sliding off of the at least one of the first and second rails.

Another illustrative embodiment of the present disclosure provides a convertible truck cap for use on a truck bed of a pickup truck. The convertible truck cap comprises: at least first and second roof bows; each of the first and second roof bows are configured to extend upwardly from the truck bed; at least the second roof bow is slidably movable to be positionable between a non-cap use stowed position and a cap use frame position with respect to the first roof bow over the truck bed; a plurality of side panels; a first side panel of the plurality of side panels spans at least between the first and second roof bows; the first side panel of the plurality of side panels selectively fastens to the first and second roof bows with at least one fastener; and at least one roof panel spans at least between the first and second roof bows at a location configured to be above the truck bed.

In the above and other embodiments, the convertible truck cap may further comprise: a first rail to be located on a first sidewall of the truck bed a second rail to be located on a second sidewall of the truck bed, wherein each of the first and second rails includes a linearly extending bearing, wherein the linearly extending bearings of the first and second rails each includes a plurality of spaced apart notches and at least the second roof bow includes at least one detent to selectively engage one of the spaced apart notches; and a third roof bow located between the first and second roof bows, wherein the third roof bow is configured to extend upwardly from the truck bed, and the third bow is independently slidably movable between the first and second roof bows.

Another illustrative embodiment of the present disclosure provides a convertible truck cap for use on a truck bed of a pickup truck. The convertible truck cap comprises: first, second and third roof bows; each of the first, second and third roof bows are configured to extend upwardly from the truck bed; at least the first and second roof bows are slidably movable to be positionable between a non-cap use stowed position and a cap use frame position with respect to the first roof bow over the truck bed; when the at least the second and third roof bows are positioned in the cap use frame position the second roof bow is spaced apart from the first roof bow; a plurality of side panels; a first side panel of the plurality of side panels spans at least between the first and second roof bows; the first side panel of the plurality of side panels selectively fastens to the first and second roof bows with at least one fastener; a second side panel of the plurality of side panels selectively fastens to the second and third roof bows with at least one fastener; a third side panel of the plurality of side panels selectively fastens to the first and second roof bows with at least one fastener at a location opposite the first side panel; a fourth side panel of the plurality of side panels selectively fastens to the second and third roof bows with at least one fastener at a location opposite the second side panel; and at least one roof panel spans at least between the first and second roof bows at a location configured to be above the truck bed.

Additional features and advantages of the convertible truck cap assembly will become apparent to those skilled in the art upon consideration of the following detailed descriptions of carrying out the convertible truck cap assembly as presently perceived.

### BRIEF DESCRIPTION OF THE DRAWINGS

The concepts described in the present disclosure are illustrated by way of example and not by way of limitation in the accompanying figures. For simplicity, and clarity of illustration, elements illustrated in the figures are not necessarily drawn to scale. For example, the dimensions of some elements may be exaggerated relative to other elements for clarity. Further, where considered appropriate, reference labels may be repeated among the figures to indicate corresponding or analogous elements.

FIG. 1 is a perspective view of a convertible truck cap;

FIG. 2 is a perspective view of the convertible truck cap of FIG. 1 with the roof panels removed;

FIG. 3 is an exploded view of the convertible truck cap;

FIG. 4 is a side view of a pickup truck, including its cab and bed sections, along with a convertible truck cap installed over the bed section;

FIG. 5 is a detail perspective view of the rear end portion of the bed section and the convertible truck cap;

FIG. 6 is a detail perspective view of a portion of the pickup truck, including the cab and bed sections, with roof bows located spaced apart on the sidewalls of the bed section;

FIG. 7 is a detail perspective view of a portion of the truck bed showing roof bows being slid along the rails;

FIG. 8 is a perspective isolated view of the rails with a roof bow sliding there along;

FIG. 9 is a top view of a rail;

FIG. 10 is a detail view of a bearing surface on the rail with a notch disposed therein;

FIG. 11 is a detail perspective view of an end portion of the rail;

FIG. 12 is an end cross-sectional view of a portion of the truck bed sidewall with a rail clamped thereto;

FIG. 13 is a perspective view of a clamp along with a cross-sectional profile view;

FIG. 14 is a perspective view of a post portion of a roof bow;

FIG. 15 is a perspective view of a corner member portion of the roof bow;

FIG. 16 is a perspective view of a roof beam portion of the roof bow;

FIG. 17 is an exploded perspective view of a joint of the roof bow;

FIG. 18 is a perspective rear view of the pickup truck with the convertible truck cap attached on the truck bed;

FIG. 19 is a cross-sectional view of a portion of a roof bow including a detent lever and rail;

FIG. 20 is another cross-sectional view of a portion of the roof bow including the detent lever and rail of FIG. 19 but with an inward force directed to the lever to move the pin from the rail;

FIG. 21 is a detail perspective underside view of a portion of a side panel with a quick-connect fastener or latch attached thereto; and

FIG. 22 is another detail perspective side view of a portion of the side panel of FIG. 21 with a quick-connect fastener or latch attached thereto.

Corresponding reference characters indicate corresponding parts throughout the several views. The exemplification set out herein illustrates embodiments of the convertible truck cap, and such exemplification is not to be construed as limiting the scope of the convertible truck cap in any manner.

### DETAILED DESCRIPTION OF THE DRAWINGS

The figures and descriptions provided herein may have been simplified to illustrate aspects that are relevant for a clear understanding of the herein described devices, systems, and methods, while eliminating, for the purpose of clarity, other aspects that may be found in typical devices, systems, and methods. Those of ordinary skill may recognize that other elements and/or operations may be desirable and/or necessary to implement the devices, systems, and methods described herein. Because such elements and operations are well known in the art, and because they do not facilitate a better understanding of the present disclosure, a discussion of such elements and operations may not be provided herein. However, the present disclosure is deemed to inherently include all such elements, variations, and modifications to the described aspects that would be known to those of ordinary skill in the art.

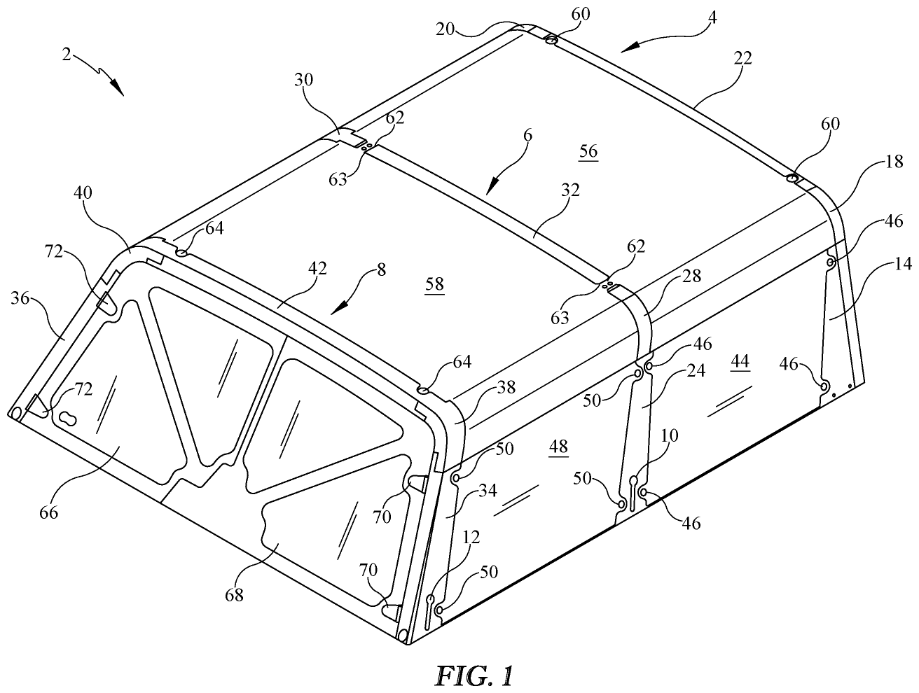

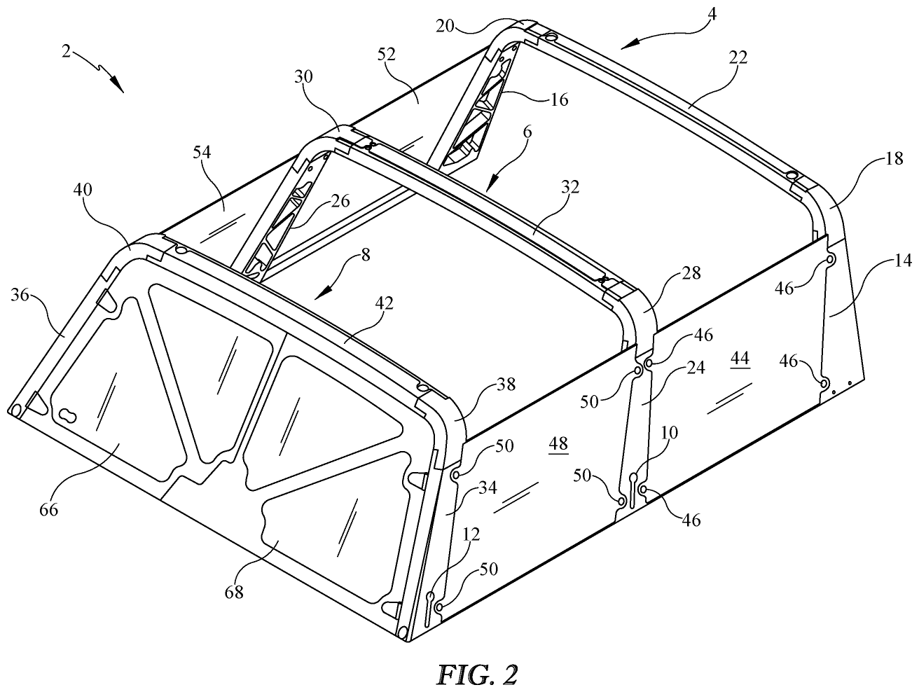

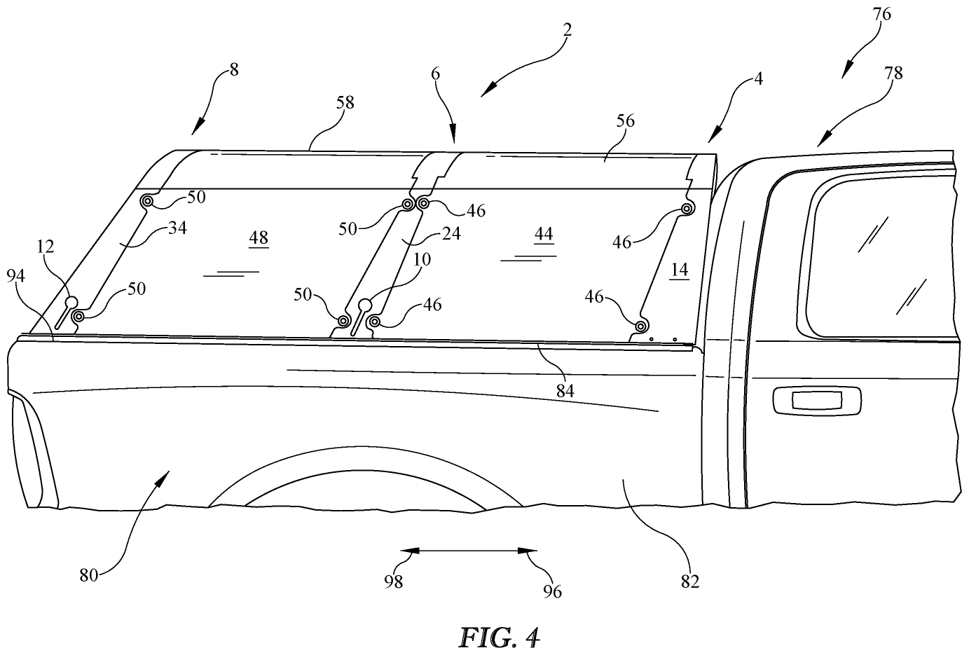

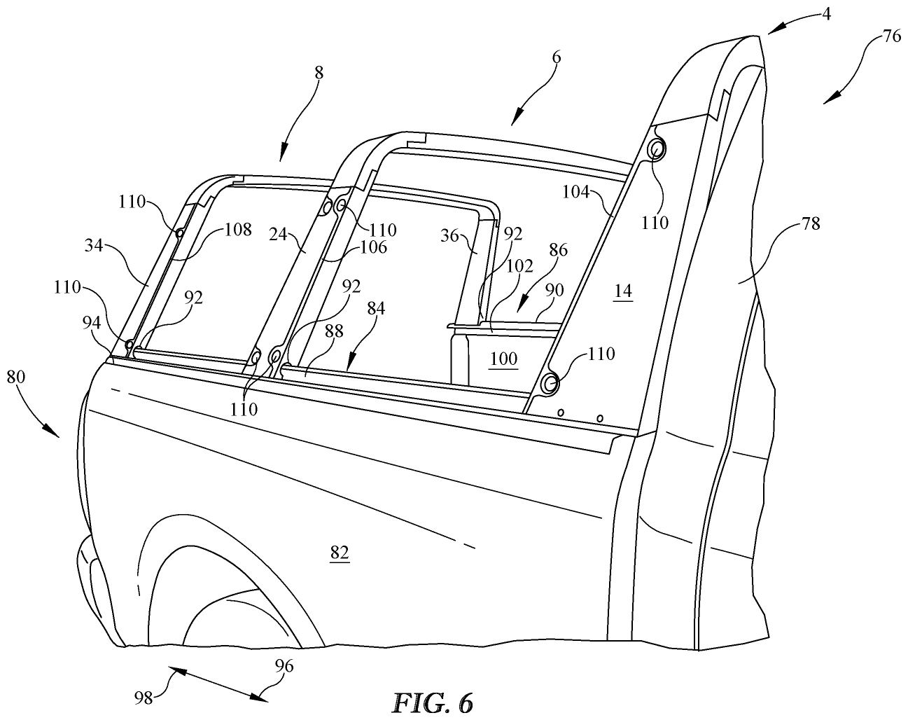

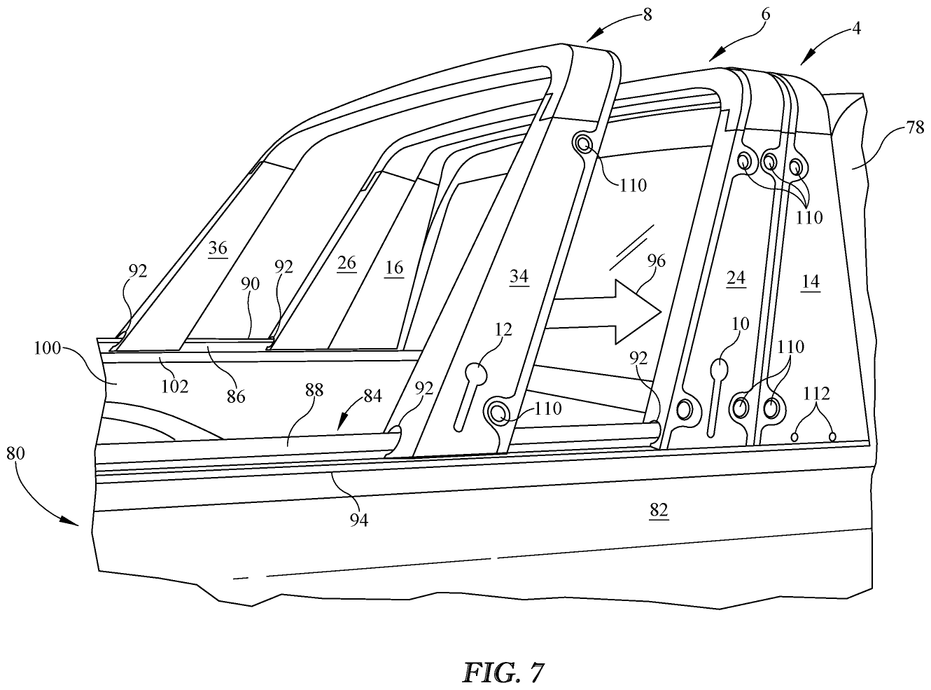

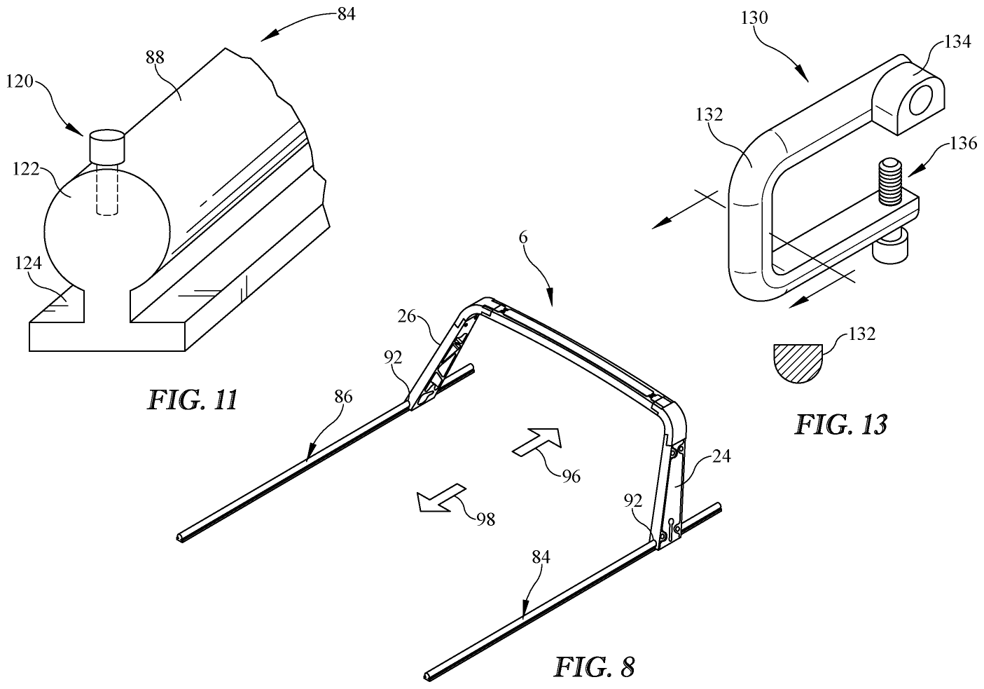

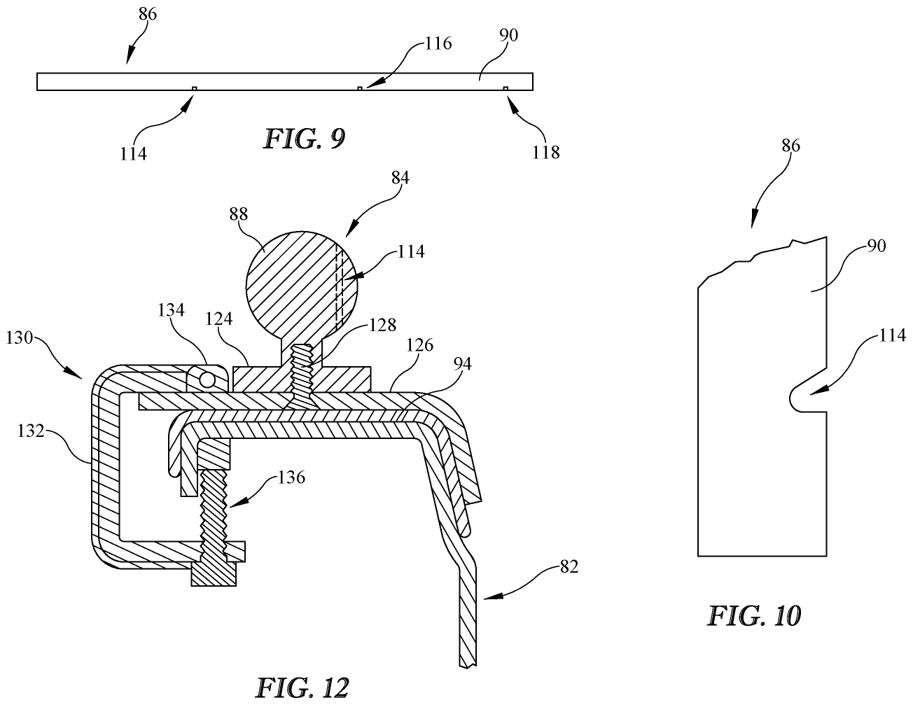

A perspective view of a convertible truck cap 2 is shown in FIG. 1. In this illustrative embodiment, convertible truck cap 2 includes a plurality of slidable roof bows and removable cover panels. Forward roof bow 4 is a forward end frame member of convertible truck cap 2 to be located adjacent the cab section of a pickup truck (see, also FIG. 4). Center roof bow 6 is illustratively a mid-area frame member for convertible truck cap 2 located near the center of same. Rear roof bow 8 is located at about the rear end of convertible truck cap 2. Each of roof bows 4, 6, and 8, are configured to extend upwardly from the sidewalls of the pickup truck bed and extend there across. They also provide the framework upon which the cover panels attach to form the body of convertible truck cap 2. Roof bows 4, 6, and 8, are configured to be slid on a rail (see FIG. 7) and moved out of the way toward a non-cap use position. Detent levers 10 and 12 selectively release detents that are engageable with notches in the rail (see FIG. 9). The notches define a stopping point for the roof bows to ensure they are properly spaced apart to receive the cover panels. Illustratively, each of roof bows 4, 6, and 8, are disassemblable into smaller components. For example, forward roof bow 4 is composed of post 14 and 16 (see, also, FIG. 2) corner members 18 and 20 coupled to posts 14 and 16, respectively, and roof beam 22 spanning between corner members 18 and 20. Similarly, center roof bow 6 may include posts 24 and 26 (see, also, FIG. 2) along with corner members 28 and 30 and roof beam 32 spanning between corner members 28 and 30 similar to that of forward roof bow 4. Lastly, rear roof bow 8 likewise extends upwardly via posts 34 and 36. Corner members 38 and 40 are illustratively the end corners of convertible truck cap 2 and attach to posts 34 and 36, respectively. Roof beam 42 extends between corner members 38 and 40 as illustratively shown. These components may be attached together by threaded bolts or screws that correspond to threaded bores in one or both of the mating roof bow components. The bolts or screws may alternatively be threaded onto nuts with the components sandwiched in between. The roof bow components may also have mating surfaces that friction fit together to form the completed roof bow.

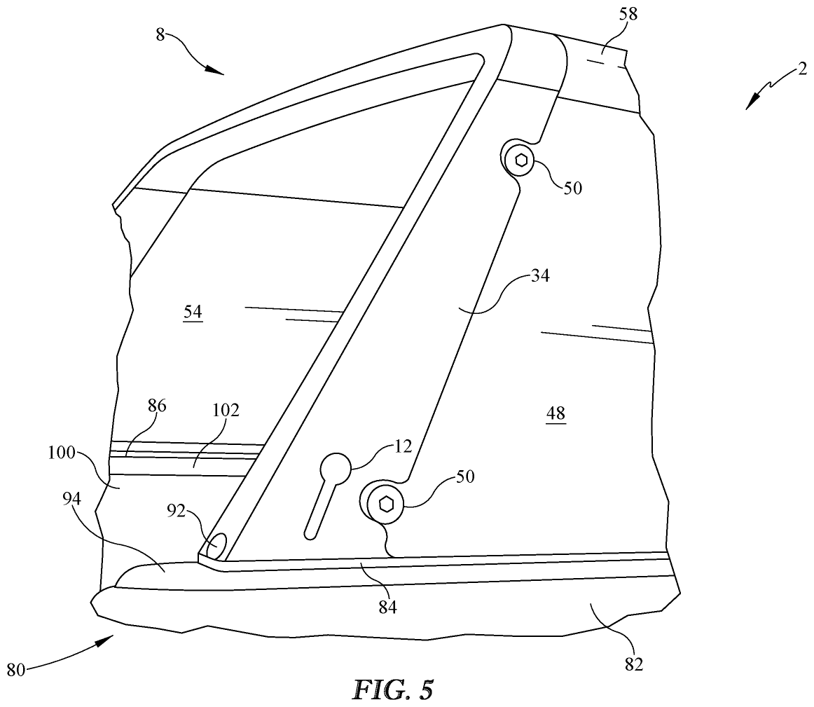

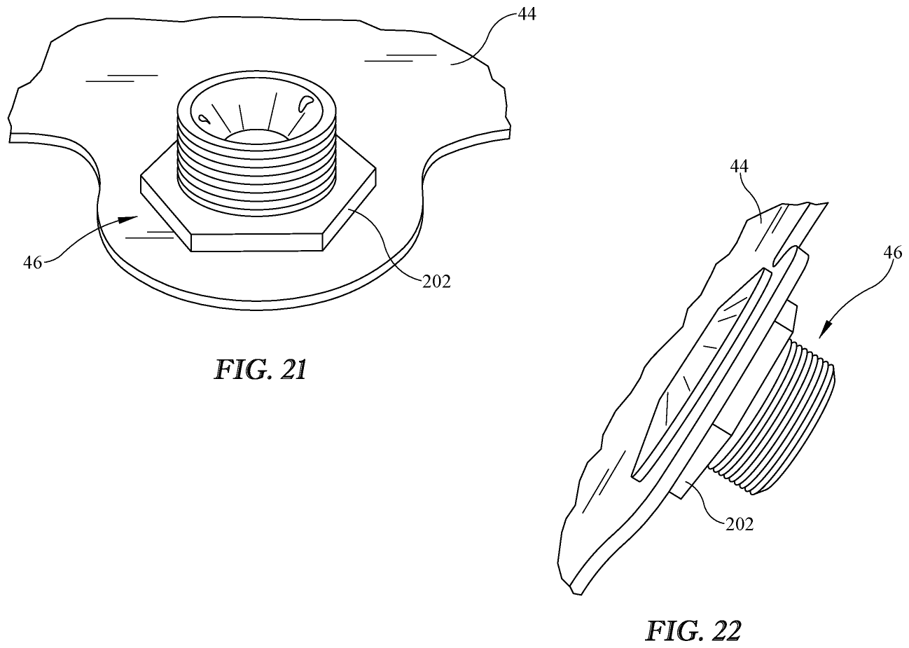

Spanning between roof bows 4, 6, and 8 are cover panels that form the skin of the truck cap. In an illustrative embodiment, side panel 44 extends between roof bow 4 and roof bow 6. Fasteners such as screws, bolts, latches, quick-connect ball latches may be employed to attach each of the cover panels onto the roof bows. Here, fasteners 46 attach side panel 44 to both posts 14 and 24 of roof bows 4 and 6, respectively. In an illustrative embodiment these fasteners may be quick-connect latches of the type described in U.S. Pat. No. 8,960,734. Such views of quick-connect fasteners 46 (and 50) are also shown in the perspective underside and side views of panel 44 in FIGS. 21 and 22. A nut 202 may abut side panel 44 in order to secure quick-connect fasteners 46 thereto. It is also appreciated as further discussed herein that the cover panels may be recessed into the roof bows in order to make the outer surface of the cover panels substantially flush with the outer surface of the roof bows (see, also, FIG. 5).

A side panel 48 is shown extending between roof bow 6 and roof bow 8. Fasteners 50 secure side panel 48 to posts 24 and 34, respectively, of roof bows 6 and 8, respectively. On the opposite side of convertible truck cap 2, side panels 52 and 54 extend between posts 16 and 26, as well as posts 26 and 36, respectively, as shown in FIG. 2. Fasteners (not shown) similar to that described with respect to fasteners 46 and 50, likewise secure side panels 52 and 54 to their respective posts. In an illustrative embodiment, these fastening means are intended to easily secure the cover panels onto the roof bows.

Overhead on convertible truck cap 2, roof panels 56 and 58 span one side of convertible truck cap 2 to the other. In particular, roof panel 56 attaches to roof beams 22 and 32 with fasteners 60 and 62. Likewise, roof panel 58 is secured via fasteners 63 and 64. These fasteners may be quick-connect latches as well. As illustratively shown, cap doors 66 and 68 are hingedly attached to posts 34 and 36, respectively, via hinges 70 and 72, respectively. It will be appreciated by the skilled artisan upon reading the present disclosure, however, that any variety of access door may be attached to rear roof bow 8. For example, the door may include an upward pivoting swing hinge at the top of roof beam 42, sliders, or other like door structures may be employed in place of doors 66 and 68. Additionally, such swing or sliding doors may be located in place of a side cover panel such as any of side panels 44, 48, 52, and 54 to offer a variety of use options for convertible truck cap 2.

Moreover, the components of the roof bows such as the upwardly extending posts, corner members, and roof beams may include tactical holes or other attachments to accommodate accessories such as rails, racks, and other like structures that are otherwise attachable to conventional pickup truck bed caps. In addition to, or in place of, one or more of the roof and side panels, brackets, or other attachments may be attached to the roof bows to store ladders, pipes, or other longitudinally extending components. Additionally, the roof bows may be positioned along the length of the rails differently than what is employed to install the side and roof panels. This provides additional flexibility for what longitudinally extending components can be carried by the roof bows. For example, a shorter ladder can be hung on the second and third roof bows if the second roof bow is slid and fixed closer to the third roof bow. This also allows additional open space in the truck bed available for other uses.

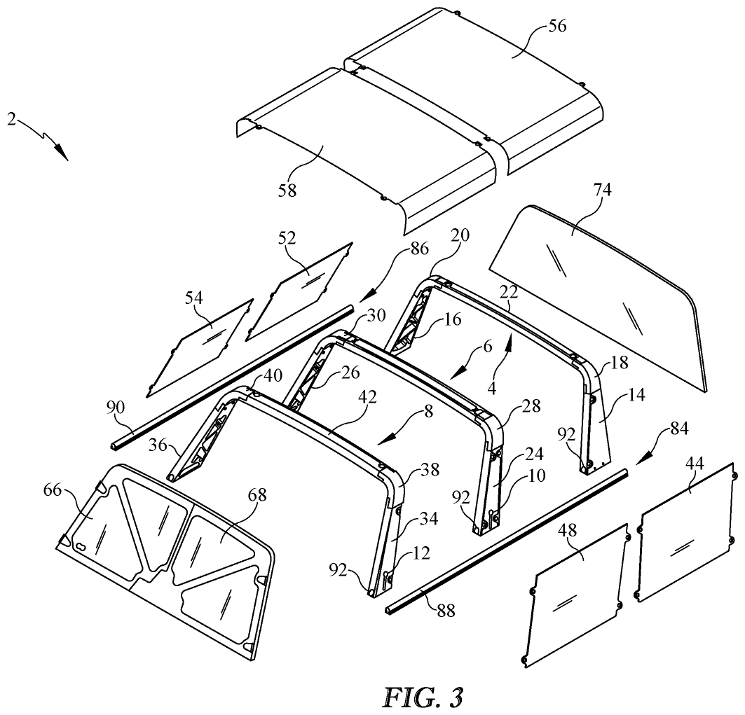

It is contemplated that any variety of brackets, hangers, or other structures may be attached to the roof bows, which themselves, may be moved to any desired position along the rails to accommodate a desired use. Additionally, the number and amount of side, roof, front, and rear door panels, that may be installed to accommodate particular uses can vary. For example, in some circumstances where additional height is necessary, only the side panels may be installed. Any combination of the structures shown in the exploded view of FIG. 3, for example, may be installed to accommodate a particular desired use. This demonstrates further versatility of the convertible truck cap 2 that is not possible with a conventional truck cap.

Another perspective view of convertible truck cap 2 it is shown in FIG. 2. This view differs from that of FIG. 1 in that roof panels 56 and 58 are removed so as to better reveal posts 16 and 26, as well as side panels 52 and 54. Here, side panels 44 and 48 are attached to posts 14 and 24, respectively, via fasteners 46 and 50, as shown. It is appreciated from this view how roof bows 4, 6, and 8 can span over a truck bed and rest on the top of its sidewalls. This view further shows how each of the roof bows may be composed of separately assembled components such as posts 14 and 16 attached to corner members 18 and 20 and joined together by roof beam 22. Similar construction exists with the other two roof bows with posts 24, 26 corner members 28, 30, and roof beam 32 of roof bow 6 and posts 34, 36, corner members 38, 40, and roof beam 42. Also shown are cap doors 66 and 68. It will be appreciated by the skilled artisan upon reading this disclosure that in other embodiments, only two roof bows such as roof bows 4 and 6, or alternatively roof bows 6 and 8 may be employed to create a partial cap over the truck bed. To that end, only some of the cover panels may be deployed as well. Also, doors 66 and 68 may be attachable to roof bow 6 instead of 8. Convertible truck cap 2 accommodates such various combinations and are contemplated to be within the scope of this disclosure.

It is notable that the shown convertible truck cap has roof bows made of billet aluminum with sheet aluminum sidewalls. Typically, metal truck caps are associated with commercial truck applications, whereas, fiberglass molded truck caps are more associated with consumer use. The embodiments herein may employ aluminum structures for truck caps designed for consumer use which is a departure from convention. That said, it is appreciated that the roof bows and panels disclosed herein may be made of a variety of materials, including billet aluminum, cast aluminum, aluminum, or other metal sheets, fiberglass, plastic, and/or other materials or combinations of materials.

An exploded perspective view of convertible truck cap 2 is shown in FIG. 3. This view depicts roof bows 4, 6, and 8 which serve as the skeletal structure of convertible truck cap 2. Side panels 44, 48, 52, and 54 serve to enclose the sides of convertible truck cap 2. Likewise cap doors 66 and 68 at the rear end and front panel 74 further enclose the structure. Roof panels 56 and 58 serve to cover convertible truck cap 2 over the truck bed. Evidenced from this view is how convertible truck cap 2 can be assembled with relative ease. With roof bows 4, 6, and 8 spaced apart and attach to the truck bed sidewalls, it becomes a simple matter of installing side panels 44, 48, 52, and 54 on each side of the truck and then installing roof panels 56 and 58 overtop. Lastly, cap doors 66 and 68 may be attached at the end of convertible truck cap 2.

Also shown in FIG. 3 are rails 84 and 86 that each include a longitudinally extending bearing surfaces 88 and 90, respectively. Each post 14, 24, 34, 16, 26, and 36 includes a bearing bore 92 configured to receive either rail 84 or rail 86. In an embodiment of convertible truck cap 2, roof bows 4, 6, and 8 when coupled to rails 84 and 86 are able to linearly slide thereon. For example, roof bows 6 and 8 may slide linearly along rails 84 and 86 between a cap use position (see FIG. 7) and a non-cap use position (see FIG. 6). This allows convertible truck cap 2 to have the versatility of either serving as an assembled truck cap as shown, or be disassembled with the roof bows 6 and 8 slid towards roof bow 4 when the cover panels are not attached thereto. This allows access to the truck bed without interference of a truck cap. This also creates additional versatility for the truck bed area of a pickup truck. Now, with relatively minor effort, the truck bed can be converted between cap use and non-cap use.

A side view of a pickup truck 76, including a cab section 78 and truck bed section 80, are shown and FIG. 4. As is conventional with pickup truck beds, this pickup truck bed 80 includes a sidewall 82 extending to top surface 94. The other side of truck bed 80 includes a sidewall 100 and top surface 102 (see FIG. 7) as well. Rail 84 attaches to a top surface 94 of sidewall 82. Rail 86 (see FIG. 6) attaches to the top surface of the opposing side wall 100 of truck bed 80. This view further shows convertible truck cap 2 attached to truck bed 80. As depicted, roof bows 4, 6, and 8 are spaced apart along the length of top surface 94 of sidewall 82. Side panels 44 and 48 are shown attached to posts 14, 24, and 34, respectively, and fastened thereto via fasteners 46 and 50. Roof panels 56 and 58 cover the truck cap spanning between roof bows 4, 6, and 8, respectively. It will be appreciated by the skilled artisan upon reading this disclosure how the configuration of side panels 44 and 48 can be easily attached to the roof bows at the sides of the truck bed. Likewise, roof panels 56 and 58 easily attach as well. Detent levers 10 and 12 are conveniently located on the lower side of posts 24 and 34, respectively. to selectively allow the roof bows to slide in either directions 96 or 98 as needed when none of the cover panels are attached (see FIG. 7).

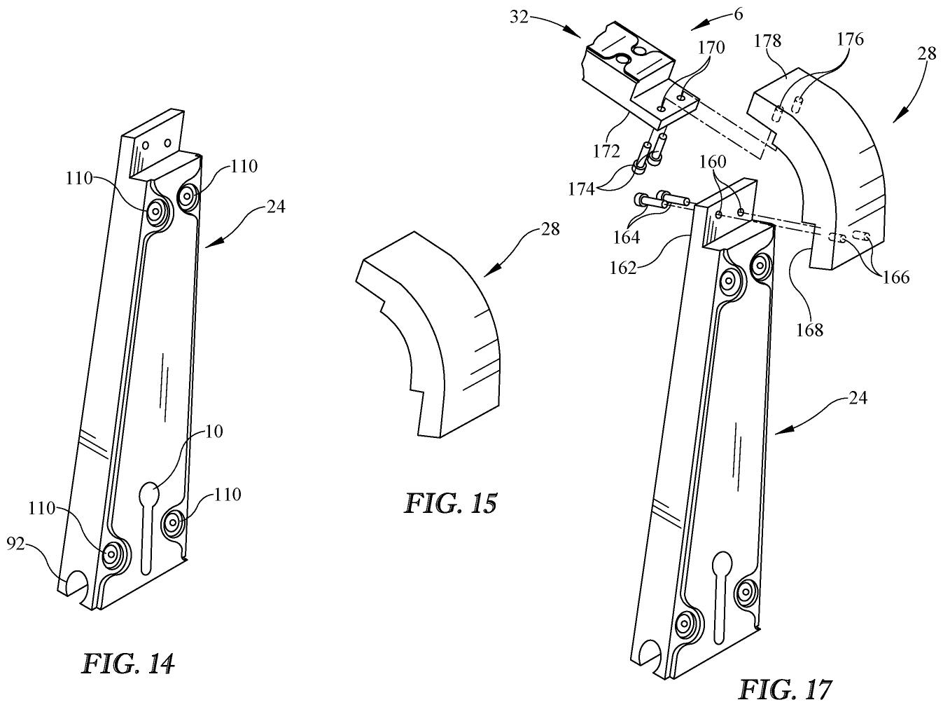

A detail perspective view of the rear end portion of convertible truck cap 2 is shown in FIG. 5. This view shows rear roof bow 8 located on top surface 94 of sidewall 82. Bearing bore 92 disposed therein receives bearing surface 88 of rail 84 (see FIG. 6). Side panel 54 is shown on the other side of truck bed 80 and side wall 100 opposing sidewall 82. Rail 86 is shown located between panel 54 and top surface 102 of sidewall 100. With roof panel 58 installed thereon, it is appreciated in this view how, when assembled, convertible truck cap 2 is configured to operate like a conventional truck cap. Detent lever 12 is shown on the lower side of posts 34 of roof bow 8. It is also appreciated from this view how the cover panels, such as side panel 48 and roof panel 58 shown herein, are attached essentially flush with roof bow 8. To help with ease of installation as further discussed herein, rabbets such as rabbet 104 (see FIGS. 6 and 14, for example) are located about the peripheries of the different roof bow components. These rabbets are recessed areas within which the cover panels can fit to create this substantially flush surface between themselves and the adjacent roof bows. This view also shows fasteners 50 which may, again, be quick-connect latches of the type describe in U.S. Pat. No. 8,960,734 or other fasteners or latches. These fasteners or latches may be secured into corresponding holes 110 (see FIG. 6) to secure cover panels, such as side panel 48 shown herein, to corresponding holes located on the roof bows. Such holes may include pin latch members that secure to the quick-connect latches of the cover panels.

A detail perspective view of a portion of the pickup truck 76 including cab section 78 and truck bed 80, are shown in FIG. 6. Rails 84 and 86 are shown attached to top surfaces 94 and 102 of sidewalls 82 and 100, respectively. In these views, no cover panels are attached to roof bows 4, 6, or 8. Bearing surface 88 of rail 84 is shown disposed through bearing bore 92 of both posts 24 and 34, respectively. Bearing surface 88 may also be disposed through bearing bore 92 in post 14 but not shown in this view. Likewise, bearing surface 90 is shown disposed in bearing bore 92 of posts 36. It is contemplated that both roof bows 6 and 8 may slide on bearing surfaces 88 and 90 in directions 96 and 98. This view also shows rabbet edges 104, 106, and 108 on posts 14, 24, and 34, respectively. It is appreciated that such rabbeted edges may be formed at any of the attachment locations between a roof bow and cover panel. Again, this creates the substantially flush surface between the roof bows and the cover panels and may enhance the aesthetics of the cap.

A plurality of bores 110 may be disposed in each of posts 14, 24, 34 (as well as post 16, 26, and 36 not shown herein) to receive corresponding fasteners on the cover panels such as side panels 44 and 48, for example. It is appreciated that such bores may include pin latch members that secure to the quick-connect latches or fasteners 46, 50 of the cover panels to attach them to the roof bows.

A detail perspective view of a portion of truck bed section 80 showing roof bows 4, 6, and 8, with at least roof bows 6 and 8 being slid in direction 96 along rails 84 and 86, are shown in FIG. 7. When it is desired to have access to truck bed section 80, without having it be capped, roof panels 56 and 58 can be removed and roof bows 6 and 8 moved out of the way, adjacent the roof bow, in order to provide clear access to truck bed section 80. This provides unique versatility to truck bed section 80 by easy assembly and disassembly of the truck cap. All that is needed is to slide the roof bows to their cap use position and attach the cover panels thereto, or remove the cover panels and slide the roof bows toward the front of truck bed section 80. This view also shows bearing bores 92 disposed through posts 24, 34, 26, and 36 so that roof bows 6 and 8 may slide along the bearing surfaces 88 and 90 between the roof bows cap use and non-cap use positions. It is appreciated that rails 84 and 86 may be supported and clamped or otherwise attached to top surfaces 94 and 102 of sidewalls 82 and 100, respectively. In a further illustrative embodiment, posts 14 and 16 of roof bow 4 may be fixed onto rails 84 and 86 adjacent cab section 78 via fasteners 112. This keeps roof bow 4 in a stationary position while only requiring roof bows 6 and 8 to slide back and forth along rails 84 and 86 between cap use and non-cap use positions. As a result, fewer structures need to be moved in order to convert truck bed 80 between cap use and non-cap use positions.

A perspective isolated view of rails 84 and 86, with roof bow 6 shown slidable thereon in directions 96 and 98, are shown in FIG. 8. This view further demonstrates the ease of moving the roof bows between their cap use position and non-cap use position. With bearing bores 92 disposed through posts 24 and 26 to receive rails 84 and 86, respectively, roof bows 6 and 8 (and in certain circumstances roof bow 4 when not secured by fasteners 112) can be moved to any desired position with relative ease.

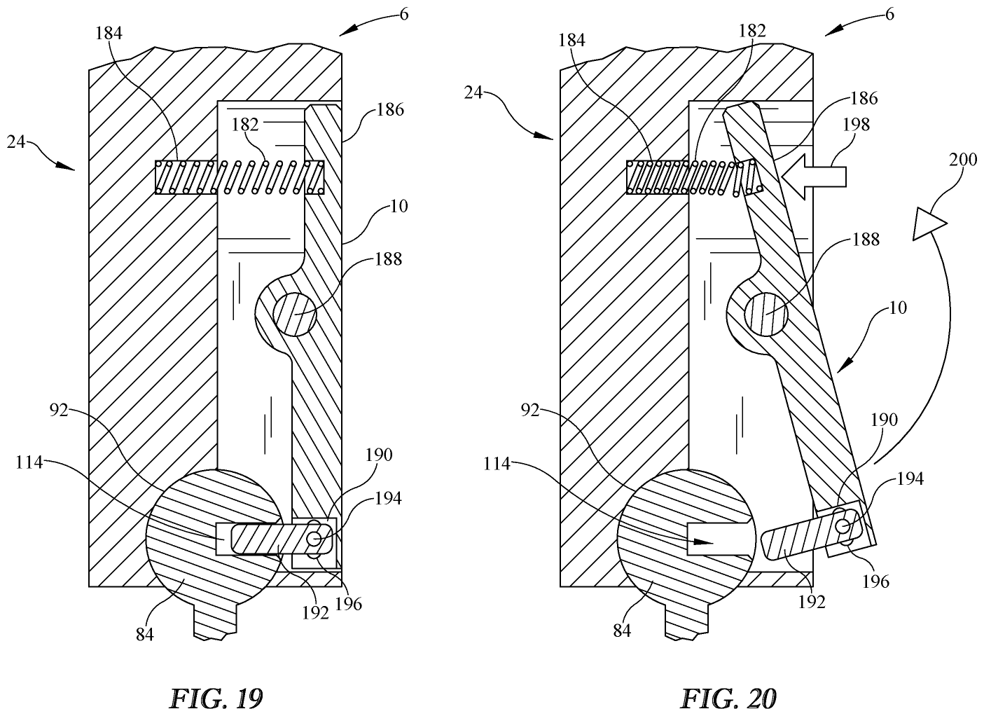

A top view of rail 86 is shown in FIG. 9. Notches 114, 116, and 118 are shown disposed along the outer side of bearing surface 90. A detail view of illustrative notch 114 disposed in bearing surface 90 is shown in FIG. 10. It is appreciated that these notches 114, 116, and 118 are spaced apart at positions along rails 86 that allows detents 192 (see also FIGS. 19 and 20) disposed in roof bows 4, 6, and 8 to engage notches 114, 116, or 118 at positions that will ensure roof bows 4, 6, 8 serve as skeletal frames for the cover panels to attach to. The predetermined locations of notches 114, 116, and 118 make it easier for the operator to know where to place roof bows 4, 6, and 8 so no measuring is needed to place the roof bows where needed for the cap-use and non-cap use positions. It will be appreciated by the skilled artisan upon reading this disclosure that such notches 114, 116, and 118 may be disposed in a rail 84, as well as in the same manner as previously described with respect to rail 86 and for the same purposes. Furthermore, it is appreciated that additional or alternative notches may be disposed in either or both rails 84 and 86 to create positive stop locations for other purposes such as non-cap use positions or for other functions.

A perspective detail view of an end portion of rail 84 is shown in FIG. 11. An illustrative stop pin 120 is shown located at end portion 122 of rail 84. Stop pin 120 or other like projection is positioned as to prevent roof bows 4, 6, or 8 from sliding completely off rail 84. Particularly, with roof bow 8, bearing bore 92 will slide along bearing surface 88 until post 34 is blocked by stop pin 120. Also shown in this view is base 124 illustratively extending laterally from bearing surface 88 of rail 84. Base 124 may be attached to a mounting plate 126 (see FIG. 12) to secure rail 84 to top surface 94 of sidewall 82 of truck bed section 80. It is appreciated that such stop member and other features so described with respect to rail 84 are also included on rail 86.

An end cross-sectional view of a portion of sidewall 82 of truck bed section 80 is shown in FIG. 12. Here, rail 84 is fastened to mounting plate 126 via fastener 128. Mounting plate 126 sets on top surface 94 of sidewall 82 and is clamped into place using clamp 130. In this illustrative embodiment, clamp 130 may be a C-type clamp that can hold mounting plate 126 securely against top surface 94. This allows rail 84 to be removably secured onto sidewall 82. Multiple C-type clamps may be employed for both rail 84 and rail 86 to secure same to their respective side walls. It is noted that C-type clamp 130 has a low profile that will not interfere with movement of the roof bows. In an illustrative embodiment, roof bows 4, 6, and 8 can set on base 124 so that C-type clamp 130, whether one or more are used, will not interfere with movement of the roof bows in either directions 96 or 98 on the rail.

A perspective view of C-type clamp 130, along with its cross-sectional profile, are shown in FIG. 13. C-type clamp 130 has an illustrative body 132 that is formed in a “C” profile so as to allow the reach necessary to clamp the rails onto the sidewalls as shown in FIG. 12. A block 134 is illustratively affixed to body 132 to provide further contact surface on mounting plate 126. A fastener 136 extends through body 132 so as to secure C-type clamp 130 onto sidewall 82.

Additionally, the roof bows being assembled from smaller components, as well as the modestly-sized side, roof, front, and rear door panels, make shipping the convertible truck cap to distributors or end customers through common carriers, such as the post office, UPS, and FedEx, for example, possible. This is a departure from conventional roof caps that span the footprint of the truck bed which may be relatively large, certainly too large for delivery through common carriers. This translates into better shipping options for residential and commercial customers.

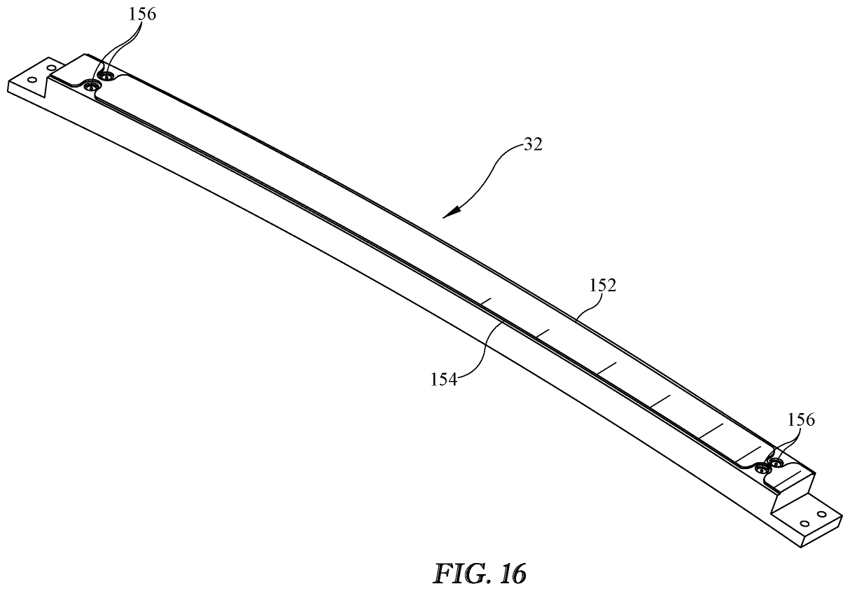

Accordingly, perspective views of the individual components of roof bow 6 are shown in FIGS. 14, 15, and 16. In the perspective view of FIG. 14, post 24 is shown with detent lever 10 and rabbet 106, with bores 110 disposed therein to receive cover panels that will be placed essentially flush with the outer surface of the roof bow. Also shown is bearing bore 92 disposed therethrough at the bottom of post 24. It is appreciated that opposing post 26 will have such similar features. Also shown are rabbets 152 and 154 in FIG. 16. Rabbets 152 and 154 receive portions of roof panels 56 and 58 so that they will set substantially flush with the outer surface of roof beam 32. Fastener holes 156 are configured to receive fasteners 62 and 63 that secure roof panels 56 and 58 to roof beam 32. It is appreciated that these components of roof bow 6 are shown herein for demonstrable purposes. The other roof bows 4 and 8 may include similar components having similar features to assemble same into their roof bow structures.

An exploded perspective view of a joint of roof bow 6 is shown in FIG. 17. This view depicts how various components of roof bow 6 attach to each other to form the full roof bow. Illustratively, through bores 160 extend through flange 162 of post 24. Fasteners such as bolts 164 extend through the through bores 160 and thread into respective threaded bores 166 disposed into flange 168 of corner member 28. By this way both post 24 and corner member 28 are fixedly attached to each other. Similarly, through bores 170 extend through flange 172 of roof beam 32 so that fasteners 174 may extend therethrough and secure to threaded bores 176 disposed in flange 178 of corner member 28 opposite flange 168. This provides secure attachment between these structures as well. It is appreciated that these components of roof bow 6 are shown herein for demonstrable purposes. The other roof bows 4 and 8 may include similar components having similar features to assemble same into their roof bow structures as well.

A cross-sectional view of a portion of post 24 of roof bow 6 along with detent lever 10 and rail 84 is shown in FIG. 19. As depicted, included with detent lever 10 is a spring 182 disposed both in a cavity 184 and pushing against button portion 186 of detent lever 10. A pivot pin 188 is located towards the middle of detent lever 10 with a cavity 190 that receives a portion of detent 192 illustratively pivotably movable within cavity 190 via pin 194 located within slot 196. It is appreciated that detent 192 may have pin 194 disposed therethrough so as to fit within slot 196 on each side of cavity 190. This causes detent 192 to have a range of motion within cavity 190 to allow detent 192 to be movable in and out of notch 114 of rail 84. With no external forces exerted on detent lever 10, detent 192 will remain inside notch 114 holding post 24 on rail 84.

Another cross-sectional view of a portion of post 24 of roof bow 6 along with detent lever 10 and rail 84 is shown in FIG. 20. Here, a force 198 is applied against button 186 of detent lever 10. That force 198 is against the bias applied by spring 182. As this happens, detent lever 10 rotates about pivot pin 188 which rotates in direction 200 in order to release detent 192 from notch 114 of rail 84. By applying this affirmative force in direction 198 against button 186, post 24 is now able to move with respect to rail 84. That said, when detent 192 is in the vicinity of notch 114 (or the other notches, for example) releasing force 198 from button 186 allows the bias in spring 182 to push outwardly in the opposite direction. This in turn causes the other side of detent lever 10 to move opposite direction 200 so that detent 192 may be reinserted into notch 114 or inserted into any other notch disposed in the rail 84 (see, also, FIG. 9). It is appreciated that detent lever 12 in post 26 of roof bow 8 may operate the same way to secure roof bow 8 onto rail 84. It is further appreciated that the detent levers on the opposing sides of the roof bows 6 and 8, respectively, may operate the same way as detent lever 10 shown herein.

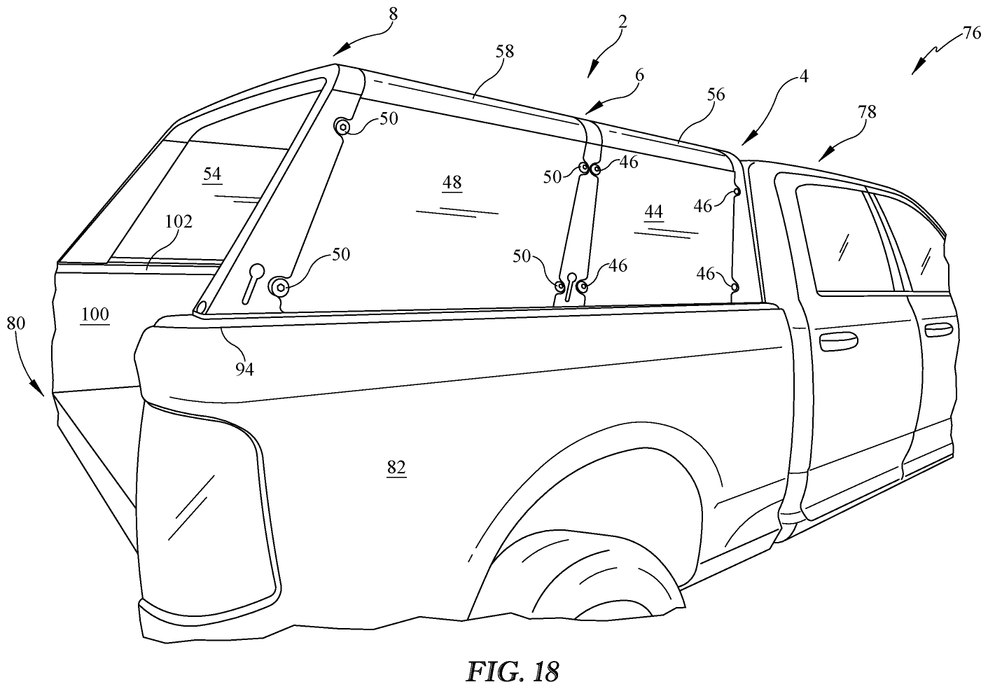

A perspective rear view of a pickup truck 76 with convertible truck cap 2 attached onto truck bed 80 is shown in FIG. 18. Like that shown in FIGS. 4 and 5, convertible truck cap 2 specifically sets on top surfaces 94 and 102 of sidewalls 82 and 100 of truck bed 80. This view further depicts how side panels 44 and 48 are attached to roof bows 4, 6, and 8 via fasteners 46 and 50. It is also appreciated from this view how cover panels such as side panels 44 and 48 and roof panels 56 and 58 may have an outer surface that is substantially flush with the outer surface of an adjacent roof bow in light of rabbet edges 104, 106, and 108 shown in FIG. 6.

It is further appreciated that this convertible truck cap assembly may include a container that can receive and store the various panels, including side, roof, and door. All of the structures are intended to be relatively lightweight so that a single person may assemble and disassemble the convertible truck cap as desired. By keeping all of the components of the convertible truck cap that does not remain on the truck bed in a container, all of those parts can be stowed in the truck bed or in a garage ready for use when needed.

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features. It should also be appreciated that, to the extent any subject matter disclosed in this non-provisional patent document conflicts with the priority application, the disclosure from this non-provisional patent document controls.

What is claimed:

1. A convertible truck cap for use on a truck bed of a pickup truck, the convertible truck cap comprising:
a first rail to be located on a first sidewall of the truck bed;
a second rail to be located on a second sidewall of the truck bed;
wherein each of the first and second rails include a linearly extending bearing;
first, second, and third roof bows;
wherein each of the first, second, and third roof bows extend upwardly from the first and second rails and over the truck bed;
wherein at least the second and third roof bows are slidably coupled to the linearly extending bearings of the first and second rails to allow the at least the second and third roof bows to slide along the first and second rails and be positionable between a non-cap use stowed position, and a cap use frame position;
wherein the at least the second and third roof bows are selectively slidable toward the first roof bow to the non-cap use stowed position;
wherein the linearly extending bearings of the first and second rails each includes a plurality of spaced apart notches and the at least the second and third roof bows each include at least one detent to selectively engage one of the plurality of spaced apart notches;
wherein when the at least the second and third roof bows are positioned in the cap use frame position the at least the second and third roof bows are spaced apart from each other and from the first roof bow;
a plurality of side panels;
wherein a first side panel of the plurality of side panels spans at least between the first and second roof bows at a location where the first and second roof bows extend upwardly from the first rail;
wherein the first side panel of the plurality of side panels selectively fastens to the first and second roof bows with at least one fastener; and
at least one roof panel spans at least between the first and second roof bows at a location configured to be above the truck bed.

2. The convertible truck cap of claim 1, wherein the at least one roof panel selectively fastens to the first and second roof bows with at least one connector.

3. The convertible truck cap of claim 1, wherein at least one of the first, second, and third roof bows is composed of at least one upward extending post, at least one laterally extending crossbeam, and at least one corner member that connects to the at least one upward extending post and the at least one laterally extending crossbeam.

4. The convertible truck cap of claim 1, wherein at least one of the first, second, and third roof bows is disassemblable into components.

5. The convertible truck cap of claim 1, further comprising a door that is attachable to at least one of the first, second, and third roof bows, wherein the door is movable with respect to the convertible truck cap between open and closed positions.

6. The convertible truck cap of claim 1, further comprising a door that is attachable to the third roof bow to allow selective access to the truck bed.

7. The convertible truck cap of claim 1, further comprising a front panel attachable to one of the first, second, and third roof bows, and to be located adjacent a cab portion of the pickup truck.

8. The convertible truck cap of claim 1, wherein the at least one fastener is held onto the at least a first side panel of the plurality of side panels when not fastened to at least one of the first and second roof bows by a structure selected from the group consisting of a washer, nut, spring nut, and clip.

9. The convertible truck cap of claim 1, further comprising a second side panel of the plurality of side panels selectively fastens to the second and third roof bows with at least one fastener, a third side panel of the plurality of side panels selectively fastens to the first and second roof bows with at least one fastener at a location opposite the first side panel, a fourth side panel of the plurality of side panels selectively fastens to the second and third roof bows with at least one fastener at a location opposite the second side panel.

10. The convertible truck cap of claim 1, further comprising a second roof panel that selectively fastens to the second and third roof bows with at least one connector.

11. The convertible truck cap of claim 1, wherein the each of the first, second, and third roof bows are composed of at least one material that is selected from the group consisting of at least one of billet aluminum, cast aluminum, aluminum, metal alloy, fiberglass, and plastic.

12. The convertible truck cap of claim 1, wherein each of the plurality of side panels are composed of a metal sheet.

13. The convertible truck cap of claim 1, wherein the at least the second and third roof bows each include at least one lever in communication with the detent to move the detent in order to release the detent from the one of the spaced apart notches.

14. The convertible truck cap of claim 1, wherein the at least one of the first, second, and third roof bows include a recess that receives the first side panel of the plurality of side panels such that at least a portion of an exterior surface of the first side panel of the plurality of side panels is essentially flush with a surface adjacent the recess of the least one of the first, second, and third roof bows.

15. The convertible truck cap of claim 1, wherein the at least the second and third roof bows are selectively slidable adjacent the first roof bow to the non-cap use stowed position.

16. The convertible truck cap of claim 1, wherein at least one of the first and second rails includes a stop member to limit movement of at least one of the first, second, and third roof bows from sliding off of the at least one of the first and second rails.

17. A convertible truck cap for use on a truck bed of a pickup truck, the convertible truck cap providing:
at least first and second roof bows;
wherein each of the first and second roof bows are configured to extend upwardly from the truck bed;
wherein at least the second roof bow is slidably movable to be positionable between a non-cap use stowed position and a cap use frame position with respect to the first roof bow over the truck bed;
a plurality of side panels;
wherein a first side panel of the plurality of side panels spans at least between the first and second roof bows;
wherein the first side panel of the plurality of side panels selectively fastens to the first and second roof bows with at least one fastener; and
at least one roof panel spans at least between the first and second roof bows at a location configured to be above the truck bed.

18. The convertible truck cap of claim 17, further comprising a first rail to be located on a first sidewall of the truck bed a second rail to be located on a second sidewall of the truck bed, wherein each of the first and second rails include a linearly extending bearing, wherein the linearly extending bearings of the first and second rails each includes a plurality of spaced apart notches and at least the second roof bow includes at least one detent to selectively engage one of the spaced apart notches.

19. The convertible truck cap of claim 17, further comprising a third roof bow located between the first and second roof bows, wherein the third roof bow is configured to extend upwardly from the truck bed, and wherein the third bow is independently slidably movable between the first and second roof bows.

20. A convertible truck cap for use on a truck bed of a pickup truck, the convertible truck cap providing:
first, second and third roof bows;
wherein each of the first, second and third roof bows are configured to extend upwardly from the truck bed;
wherein at least the first and second roof bows are slidably movable to be positionable between a non-cap use stowed position and a cap use frame position with respect to the first roof bow over the truck bed;
wherein when the at least the second and third roof bows are positioned in the cap use frame position, the second roof bow is spaced apart from the first roof bow;
a plurality of side panels;
wherein a first side panel of the plurality of side panels spans at least between the first and second roof bows;
wherein the first side panel of the plurality of side panels selectively fastens to the first and second roof bows with at least one fastener;
a second side panel of the plurality of side panels selectively fastens to the second and third roof bows with at least one fastener;
a third side panel of the plurality of side panels selectively fastens to the first and second roof bows with at least one fastener at a location opposite the first side panel;
a fourth side panel of the plurality of side panels selectively fastens to the second and third roof bows with at least one fastener at a location opposite the second side panel; and
at least one roof panel spans at least between the first and second roof bows at a location configured to be above the truck bed.
